(19) United States
(12) Patent Application Publication
(10) Pub. No.: US 2016/0002501 A1
(43) Pub. Date: Jan. 7, 2016

(54) DOUBLE SIDED ADHESIVE FILM, ADHESIVE LAYER-EQUIPPED TRANSPARENT PLATE, AND LAMINATE

(71) Applicant: Asahi Glass Company, Limited, Chiyoda-ku (JP)

(72) Inventors: Satoshi NIIYAMA, Chiyoda-ku (JP); Naoko Aoki, Chiyoda-ku (JP)

(73) Assignee: Asahi Glass Company, Limited, Chiyoda-ku (JP)

(21) Appl. No.: 14/751,683

(22) Filed: Jun. 26, 2015

(30) Foreign Application Priority Data
Jul. 7, 2014 (JP) 2014-139912

(51) Int. Cl. C09J 7/02; B32B 7/12

(52) U.S. Cl. CPC C09J 7/0217; B32B 7/12; B32B 2457/20; B32B 2405/00; B32B 2307/412; C09J 2433/003

(57) ABSTRACT

To provide a double sided adhesive film, an adhesive layer-equipped transparent plate and a laminate, capable of improving reworkability. One embodiment of the double sided adhesive film of the present invention is a double sided adhesive film which has an adhesive layer made of a resin composition as a forming material and which is capable of bonding an adherend and a protective plate, wherein the adhesive layer has a first surface and a second surface on the opposite side of the first surface, the composition of the resin composition at the first surface and the composition of the resin composition at the second surface are different from each other, and the adhesive force between the first surface and the protective plate is larger than the adhesive force between the second surface and the adherend.

### TECHNICAL FIELD

The present invention relates to a double sided adhesive film, an adhesive layer-equipped transparent plate, and a laminate.

### BACKGROUND ART

A double sided adhesive sheet to be used for bonding a protective plate to a display device such as a display panel has been proposed (e.g. Patent Document 1).

### PRIOR ART DOCUMENT

### Patent Document

Patent Document 1: JP-A-2009-263502

### DISCLOSURE OF INVENTION

### Technical Problem

Such a double sided adhesive sheet (double sided adhesive film) is desired to have high reworkability, such that in a case where, for example, the bonding position of a protective plate to a display device is displaced, the protective plate may be once peeled off from the display device and then bonded again.

However, for example, with such a double sided adhesive film as shown in the above Patent Document 1, once a protective plate is thereby bonded to a display device, if it is attempted to peel off the protective plate, the adhesive layer tends to be ruptured and divided between the protective plate and the display device in many cases, and divided pieces of the adhesive layer are likely to adhere to the protective plate and the display device. Therefore, it has been difficult to bond the protective plate and the display device again.

One embodiment of the present invention has been made in view of the above problem, and it is an object of the present invention to provide a double sided adhesive film, an adhesive layer-equipped transparent plate, and a laminate, capable of improving the reworkability.

### Solution to Problem

One embodiment of the double sided adhesive film of the present invention is a double sided adhesive film which has an adhesive layer made of a resin composition as a forming material and which is capable of bonding an adherend and a protective plate, wherein the adhesive layer has a first surface and a second surface on the opposite side of the first surface, the composition of the resin composition at the first surface and the composition of the resin composition at the second surface are different from each other, and the adhesive force between the first surface and the protective plate is larger than the adhesive force between the second surface and the adherend.

The construction may be such that the shear modulus at 25° C. of the entire adhesive layer is from 1 kPa to 50 kPa.

The construction may be such that the resin composition contains a chain transfer agent, and the proportion of the chain transfer agent at the first surface is larger than the proportion of the chain transfer agent at the second surface.

The construction may be such that the resin composition contains a polar component, and the proportion of the polar component at the first surface is larger than the proportion of the polar component at the second surface.

The construction may be such that the resin composition contains a non-curable component, and the proportion of the non-curable component at the first surface is smaller than the proportion of the non-curable component at the second surface.

The construction may be such that the adhesive layer comprises a first adhesive layer having the first surface and a second adhesive layer having the second surface, and the composition of the resin composition in the first adhesive layer and the composition of the resin composition in the second adhesive layer are different from each other.

The construction may be such that the adhesive layer further contains a third adhesive layer provided between the first adhesive layer and the second adhesive layer, and the composition of the resin composition in the third adhesive layer is different from the composition of the resin composition in the first adhesive layer and is different from the composition of the resin composition in the second adhesive layer.

One embodiment of the adhesive layer-equipped transparent plate of the present invention is an adhesive layer-equipped transparent plate comprising a transparent plate and the above double sided adhesive film bonded to the transparent plate.

One embodiment of the adhesive layer-equipped transparent plate of the present invention is an adhesive layer-equipped transparent plate to be bonded to an adherend, which comprises a transparent plate and an adhesive layer formed on at least one surface of the transparent plate, wherein the adhesive layer is formed of a resin composition and has a first surface on the transparent plate side and a second surface on the opposite side of the first surface, the composition of the resin composition at the first surface and the composition of the resin composition at the second surface are different from each other, and the adhesive force between the first surface and the transparent plate is larger than the adhesive force between the second surface and the adherend.

The construction may be such that the shear modulus at 25° C. of the entire adhesive layer is from 1 kPa to 50 kPa.

The construction may be such that the adhesive layer is formed of laminated at least two types of the resin composition different in the composition from one another, and is provided on each of both surfaces of the transparent plate.

The construction may be such that the resin composition contains a chain transfer agent, and the proportion of the chain transfer agent at the first surface is larger than the proportion of the chain transfer agent at the second surface.

The construction may be such that the resin composition contains a polar component, and the proportion of the polar component at the first surface is larger than the proportion of the polar component at the second surface.

The construction may be such that the resin composition contains a non-curable component, and the proportion of the non-curable component at the first surface is smaller than the proportion of the non-curable component at the second surface.

One embodiment of the laminate of the present invention is a laminate comprising a transparent plate, an adhesive layer formed on at least one surface of the transparent plate, and an adherend bonded to the transparent plate via the adhesive layer, wherein a resin composition forming the adhesive layer contains a non-curable component, the adhesive layer has a first surface on the transparent plate side and a second surface on the opposite side of the first surface, and the proportion of the non-curable component at the first surface is smaller than the proportion of the non-curable component at the second surface.

The construction may be such that the adherend is a display device.

### Advantageous Effect of Invention

According to one embodiment of the present invention, it is possible to provide a double sided adhesive film, an adhesive layer-equipped transparent plate and a laminate, capable of improving reworkability.

### BRIEF DESCRIPTION OF DRAWINGS

FIG. 1 is a plan view showing a double sided adhesive film of the first embodiment.

FIG. 2 is a view showing the double sided adhesive film of the first embodiment and is a cross-sectional view along II-II in FIG. 1.

FIG. 3 is a cross-sectional view showing an adhesive layer-equipped transparent plate of the first embodiment.

FIG. 4 is a schematic construction diagram showing a production apparatus for producing the double sided adhesive film of the first embodiment.

FIG. 5 is a schematic construction diagram showing a production apparatus for producing the double sided adhesive film of the first embodiment.

FIGS. 6A and 6B are illustrative drawings for illustrating the effect of the first embodiment.

FIG. 7 is a schematic construction diagram showing another example of a production apparatus for producing the double sided adhesive film of the first embodiment.

FIG. 8 is a cross-sectional view showing a double sided adhesive film of the second embodiment.

FIG. 9 is a cross-sectional view showing a double sided adhesive film of the third embodiment.

FIG. 10 is a cross-sectional view showing an embodiment of the display device.

### DESCRIPTION OF EMBODIMENTS

Now, embodiments of the present invention will be described with reference to the drawings.

Here, it should be mentioned that the scope of the present invention is by no means limited to the following embodiments, and optional modifications may be made within the range of the technical concept of the present invention. Further, in the following drawings, in order to make various constructions easily understandable, the respective structures may be shown as differentiated in their sizes, numbers, etc. from the real structures.

In this specification, “transparent” means that after a plate and a display surface of a display panel are bonded via an adhesive layer without a void space, whole or part of a display image on the display panel is visible through the plate without optical distortion. Accordingly, a plate can be regarded as “transparent” so long as a display image on a display panel is visible without optical distortion thorough the plate even if part of light which enters the plate from the display panel is absorbed or reflected by the plate, or even if the plate has a low visible light transmittance e.g. by a change in the phase.

In this specification, “(meth)acrylate” means an acrylate or a methacrylate.

In this specification, “thickness” means a thickness measured by a measuring method by means of e.g. a microgauge or a laser displacement meter. Further, “average thickness” shall be an average value of thicknesses measured at 10 locations.

### First Embodiment

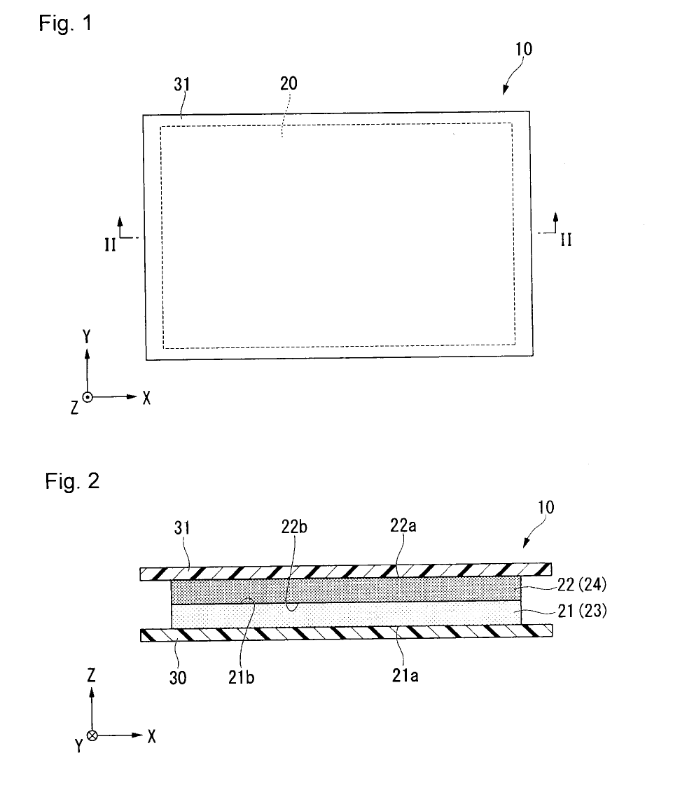

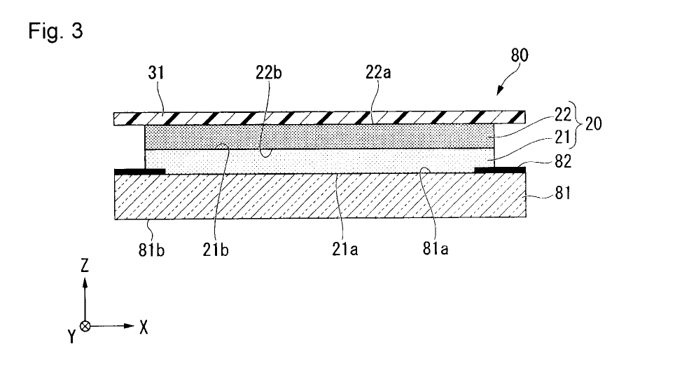

FIG. 1 is a plan view showing a double sided adhesive film 10 of this embodiment. FIG. 2 is a view showing the double sided adhesive film 10 of this embodiment and is a cross-sectional view along II-II in FIG. 1. FIG. 3 is a cross-sectional view showing an adhesive layer-equipped transparent plate 80. The adhesive layer-equipped transparent plate 80 is, for example, one having the double sided adhesive film 10 bonded to a protective plate (transparent plate) 81.

In the following description, a X-Y-Z coordinate system is set, and with reference to the X-Y-Z coordinate system, the positional relation of each construction will be described. In such a case, the lamination direction (see FIG. 2) of an adhesive layer 20 is set to be Z-axis direction, the short direction (see FIG. 1) in the planar view of the double sided adhesive film 10 is set to be Y-axis direction, and the longitudinal direction in the planar view of the double sided adhesive film 10, orthogonally intersecting the Z-axis direction and the Y-axis direction, is set to be X-axis direction.

### <Double Sided Adhesive Film>

As shown in FIGS. 1 and 2, the double sided adhesive film 10 of this embodiment has an adhesive layer 20. The double sided adhesive film 10 is, for example, an adhesive film to be bonded to a protective plate 81 (see FIG. 3) and to be used for producing an adhesive layer-equipped transparent plate 80.

To a bonding surface (first surface) 21a at one side (−Z side) of the adhesive layer 20, a first protective film 30 is bonded. To a bonding surface (second surface) 22a at the other side (+Z side) of the adhesive layer 20, a second protective film 31 is bonded.

### [Adhesive Layer]

The planar view (X-Y planar view) shape of the adhesive layer 20 is not particularly limited, and, for example, in this embodiment, it is rectangular as shown in FIG. 1. As shown in FIG. 2, the adhesive layer 20 comprises a high adhesion adhesive layer (first adhesive layer) 21 and a low adhesion adhesive layer (second adhesive layer) 22.

The high adhesion adhesive layer 21 has a bonding surface 21a. The low adhesion adhesive layer 22 has a bonding surface 22a. The high adhesion adhesive layer 21 and the low adhesion adhesive layer 22 are formed as laminated. In the following description, as between the surfaces of the high adhesion adhesive layer 21 and the low adhesion adhesive layer 22 which are in contact with each other, the surface of the high adhesion adhesive layer 21 will be referred to as a lamination surface 21b, and the surface of the low adhesion adhesive layer 22 will be referred to as a lamination surface 22b.

The high adhesion adhesive layer 21 is, for example, an adhesive layer on the side to be bonded to a protective plate 81 to protect e.g. a liquid display panel of a display device. The low adhesion adhesive layer 22 is, for example, an adhesive layer on the side to be bonded to e.g. a liquid display panel of a display device. Although details will be described later, the adhesive force of the high adhesion adhesive layer 21 is larger than the adhesive force of the low adhesion adhesive layer 22.

The thickness (length in Z axis direction) of the adhesive layer 20 is preferably from about 0.1 mm to 2.0 mm, more preferably from about 0.2 mm to 0.8 mm. When the thickness of the adhesive layer 20 is at least 0.1 mm, in a case where a protective plate 81 and a display device are bonded, the adhesive layer 20 will effectively absorb a shock by an external force from the protective plate 81 side, etc. and can thereby protect the main body of the display device. Further, even if a foreign matter not exceeding the thickness of the adhesive layer 20 is included between the protective plate 81 and the display device, the thickness of the adhesive layer 20 will not change substantially, and there will be little influence to the light transmitting performance. When the thickness of the adhesive layer 20 is at most 2.0 mm, it becomes easy to bond the protective plate 81 to the display device via the adhesive layer 20, and the entire thickness of the display device will not become unnecessarily thick.

In this embodiment, the thickness of the adhesive layer 20 is the sum of the thickness of the high adhesion adhesive layer 21 and the thickness of the low adhesion adhesive layer 22. The thickness of the high adhesion adhesive layer 21 and the thickness of the low adhesion adhesive layer 22 may be the same or different. In a case where the shear modulus of the low adhesion adhesive layer 22 is larger than the shear modulus of the high adhesion adhesive layer 21, it is preferred to adjust the thickness of the low adhesion adhesive layer 22 to be smaller than the thickness of the high adhesion adhesive layer 21.

The shear modulus of the adhesive layer 20 is preferably within a range of from 10² Pa to 10⁵ Pa, more preferably within a range of from 10³ Pa to 10⁴ Pa. When the shear modulus of the adhesive layer 20 is at least 10² Pa, it is easy to maintain the shape of the adhesive layer 20. Further, when the shear modulus of the adhesive layer 20 is at least 10² Pa, for example, it is possible to sufficiently fix the protective plate 81 to the display device, and at the time of bonding the protective plate 81 and the display device, the adhesive layer 20 will be less likely to be deformed by e.g. a pressure at the time of bonding. On the other hand, when the shear modulus of the adhesive layer is at most 10⁵ Pa, even if air bubbles are formed at the interface between the adhesive layer 20 and the display device at the time of bonding to the display device, such air bubbles will disappear in a short time and will be less likely to remain, such being desirable. A more preferred range of the shear modulus of the entire adhesive layer 20 of this embodiment, is at 25° C. from 1 kPa to 50 kPa, i.e. at least 10³ Pa and at most 5×10⁴ Pa.

The adhesive 20 is constituted by a transparent resin obtained by curing a photocurable liquid resin composition. That is, in this embodiment, the high adhesion adhesive layer 21 and the low adhesion adhesive layer 22 are formed of photocurable resin compositions.

In the following description, in order to simplify the description, the resin composition to form the high adhesion adhesive layer 21 will be referred to as a high adhesion resin composition 23, and the resin composition to form the low adhesion adhesive layer 22 will be referred to as a low adhesion resin composition 24.

The composition of the high adhesion resin composition 23 and the composition of the low adhesion resin composition 24 are different from each other. That is, the composition of the resin composition at the bonding surface 21a of the adhesive layer 20 and the composition of the resin composition at the bonding surface 22a of the adhesive layer 20 are different from each other. Thus, the adhesive layer 20 is constituted by laminated at least two types of the resin compositions different in their compositions from each other.

Here, in this specification, the “compositions” of the resin compositions being different means both of a case where the types of components contained in the resin compositions are different and a case where the proportions of the same components contained in the resin compositions are different.

The following description in this embodiment will be made with respect to a case where the composition of the high adhesion resin composition 23 and the composition of the low adhesion resin composition 24 are the same with respect to the types of components contained and are different from each other with respect to the proportions of the respective components contained.

Specifically, the composition of the high adhesion resin composition 23 and the composition of the low adhesion resin composition 24 are adjusted so that the adhesive force of the high adhesion adhesive layer 21 becomes larger than the adhesive force of the low adhesion adhesive layer 22. By such adjustment, in such a case that after the protective plate 81 and the display device are once bonded, the protective plate 81 is peeled off, the adhesive layer 20 will remain on the protective plate 81 side, whereby rebonding will be easy. Specific compositions of the high adhesion resin composition 23 and the low adhesion resin composition 24 will be described later.

The adhesive force of the low adhesion adhesive layer 22 is, for example, at least 0.1 N/25 mm and at most 0.8 N/25 mm. The adhesive force of the high adhesion adhesive layer 21 is at least three times the adhesive force of the low adhesion adhesive layer 22. When the adhesive force of the high adhesion adhesive layer 21 and the adhesive force of the low adhesion adhesive layer 22 are adjusted to be within such a range, it is possible to effectively improve reworkability.

In this specification, the adhesive force (N/25 mm) is one measured by the following method.

Firstly, a double sided adhesive film is cut to have a length of 98 mm and a width of 25 mm to obtain a test specimen. And, the protective film is partially peeled to bring such a state that the protective film and the adhesive layer are bonded only for 30 mm in the length direction.

Then, the peeled-side end of the protective film is pulled upward at 90° to the main surface of the adhesive layer by means of a tension tester (Tensilon manufactured by Orientec Co., Ltd.) to have the remaining portion peeled off. The peeling rate was adjusted to be 50 mm/min., and the force required for the peeling of the protective film was taken as the adhesive force.

### [Protective Films]

The first protective film 30 and the second protective film 31 have the same construction, and therefore, in the following description, only the first protective film 30 will be described as a representative.

The first protective film 30 is required not to firmly bond to the adhesive layer 20. Accordingly, the first protective film 30 is preferably a protective film of e.g. a PET (polyethylene terephthalate) film having a release agent of e.g. a silicone resin coated on the surface to be in contact with the adhesive layer 20, or a protective film having a relatively low adhesive property, of e.g. polyethylene, polypropylene or a fluorinated resin.

The adhesive force between the first protective film 30 and the high adhesion adhesive layer 21, and the adhesive force between the second protective film 31 and the low adhesion adhesive layer 22 may be suitably set. However, in the presentation of the adhesive layer-equipped transparent plate as shown in FIG. 3, it is preferred that the adhesive force between the first protective film 30 and the high adhesion adhesive layer 21 is smaller than the adhesive force between the second protective film 31 and the low adhesion adhesive layer 22.

A preferred thickness of the first protective film 30 varies depending upon the resin to be used, and in the case of using a hard film such as a release agent-coated PET film, it is preferably from 0.025 mm to 0.175 mm, further preferably from 0.038 mm to 0.125 mm. In the case of using a relatively flexible film of e.g. polyethylene or polypropylene, it is preferably from 0.04 mm to 0.2 mm, further preferably from 0.06 mm to 0.1 mm. When it is at least 0.025 mm, it is possible to prevent deformation of the first protective film 30 at the time of peeling the first protective film 30 from the adhesive layer 20, and when it is at most 0.2 mm, the first protective film 30 is easily bent at the time of peeling so that it can be easily peeled.

Further, it is more preferred to provide a barrier layer at a part of the first protective film 30 in order to prevent an exterior gas (such as oxygen gas, nitrogen gas, water vapor, etc.) from entering into the adhesive layer 20 via the first protective film 30.

### [Composition of Resin Composition]

Now, the resin composition of the adhesive layer 20 i.e. the components constituting the high adhesion resin composition 23 and the low adhesion resin composition 24 will be described.

The resin composition of this embodiment comprises a curable compound (II) having a photocurable property, a photopolymerization initiator (C2), a non-curable oligomer (D) (non-curable component) and a chain transfer agent (E).

### (Curable Compound (II))

The curable compound (II) preferably comprises at least one type of oligomer (A′) having a curable group and having a number average molecular weight of from 1,000 to 100,000 and at least one type of monomer (B′) having a curable group and having a molecular weight of from 125 to 600. When this type of curable compound (II) is used, it is easy to adjust the viscosity of the resin composition to be within a preferred range.

The curable group in the oligomer (A′) or the monomer (B′) may, for example, be an addition-polymerizable unsaturated group (such as an acryloyloxy group or a methacryloyloxy group), or a combination of an unsaturated group and a thiol group, and a group selected from an acryloyloxy group and a methacryloyloxy group is preferred from such a viewpoint that the curing speed is high, and a highly transparent adhesive layer 20 is thereby obtainable.

The curable group in the oligomer (A′) and the curable group in the monomer (B′) may be the same or different from each other. The curable group in the relatively high molecular weight oligomer (A′) tends to have a lower reactivity than the curable group in the relatively low molecular weight monomer (B′). Therefore, it is likely that curing of the monomer (B′) proceeds first to rapidly increase the viscosity of the entire composition, whereby the curing reaction tends to be non-uniform. In order to minimize the difference in the reactivity of the curable groups in both and to obtain a uniform adhesive layer 20, it is more preferred to adjust the curable group in the oligomer (A′) to be an acryloyloxy group having relatively high reactivity and to adjust the curable group in the monomer (B′) to be a methacryloyloxy group having a relatively low reactivity. In order to shorten the time required for the curing reaction or to increase the adhesive force of the adhesive layer 20, it is preferred to adjust each of the curable groups in the oligomer (A′) and the monomer (B′) to be an acryloyloxy group.

### (Oligomer (A′))

The number average molecular weight of the oligomer (A′) is from 1,000 to 100,000, preferably from 10,000 to 70,000. When the number average molecular weight of the oligomer (A′) is within this range, it is easy to adjust the viscosity of the resin composition to be within the above range. The number average molecular weight of the oligomer (A′) is a number average molecular weight calculated as polystyrene, obtained by the measurement of GPC. Here, in a case where in the measurement of GPC, a peak of a non-reacted low molecular component (such as a monomer) appears, the number average molecular weight is obtained by excluding such a peak.

The oligomer (A′) is preferably one having from 1.8 to 4 curable groups per one molecule on average. The oligomer (A′) may, for example, be a urethane oligomer having a urethane bond, a poly(meth)acrylate of a polyoxyalkylene polyol or a poly(meth)acrylate of a polyester polyol. A urethane oligomer (A2) is preferred from such a viewpoint that it is possible to widely adjust the mechanical properties of the resin after curing, the adhesion to the plate, etc. by e.g. designing the molecule of the urethane chain.

The urethane oligomer (A2) is preferably one synthesized by a method wherein a polyol and a polyisocyanate are reacted to obtain a prepolymer having an isocyanate group, and then, a monomer (B2) is reacted to the isocyanate group of the prepolymer. The polyol and the polyisocyanate may be known compounds, for example, polyol (i), diisocyanate (ii), etc. disclosed as raw materials for a urethane oligomer (a) disclosed in WO2009/016943, which are incorporated in this specification by reference.

The content proportion of the oligomer (A′) is preferably from 20 mass % to 90 mass %, more preferably from 30 mass % to 80 mass %, in the entirety (100 mass %) of the curable compound (II), i.e. the sum (100 mass %) of the oligomer (A′) and the monomer (B′). When the proportion of the oligomer (A′) is at least 20 mass %, the heat resistance of the adhesive layer 20 will be good. When the proportion of the oligomer

(A′) is at most 90 mass %, the curability of the resin composition and the adhesion between the protective plate and the adhesive layer 20 will be good.

### (Monomer (B′))

The molecular weight of the monomer (B′) is from 125 to 600, preferably from 140 to 400. When the molecular weight of the monomer (B′) is at least 125, it is possible to prevent volatilization of the monomer at the time of forming the adhesive layer 20 by using a reduced pressure means. When the molecular weight of the monomer (B′) is at most 600, the adhesion of the adhesive layer 20 will be good. The monomer (B′) is preferably one having from 1 to 3 curable groups in one molecule, from the viewpoint of the curability of the resin composition and the mechanical properties of the adhesive layer 20. The content proportion of the monomer (B′) is preferably from 10 mass % to 80 mass %, more preferably from 20 mass % to 70 mass %, in the entirety (100 mass %) of the curable compound (II), i.e. the sum (100 mass %) of the oligomer (A′) and the monomer (B′).

In this embodiment, the monomer (B′) has a curable group and further contains a monomer (B3) (polar component) having a hydroxy group. The monomer (B3) will contribute to stabilization of the non-curable oligomer (D). Further, when the monomer (B3) is incorporated, good adhesion between the protective plate 81 and the adhesive layer 20 will be readily obtainable. The monomer (B3) having a hydroxy group is particularly preferably 2-hydroxybutyl methacrylate, 2-hydroxybutyl acrylate or 4-hydroxybutyl acrylate. The content proportion of the monomer (B3) is preferably from 10 mass % to 60 mass %, more preferably from 20 mass % to 50 mass %, in the entirety (100 mass %) of the curable compound (II), i.e. the sum (100 mass %) of the oligomer (A′) and the monomer (B′). When the content proportion of the monomer (B3) is at least 10 mass %, it is possible to readily obtain the effect to improve the stability of the resin composition and the effect to improve the adhesion between the adhesive layer 20 and the protective plate 81 or a display panel.

The monomer (B′) preferably contains the following monomer (B4).

The monomer (B4) is constituted by at least one member selected from alkyl acrylates and alkyl methacrylates having a C₈₋₂₂ alkyl group. The monomer (B4) may, for example, be n-decyl acrylate, n-dodecyl acrylate, n-dodecyl methacrylate, isooctadecyl acrylate, n-octadecyl methacrylate, n-behenyl methacrylate, etc., and n-decyl acrylate, n-dodecyl acrylate or n-dodecyl methacrylate, is preferred.

### (Photopolymerization Initiator (C2))

The photopolymerization initiator (C2) may be a photopolymerization initiator of e.g. acetophenone type, ketal type, benzoin or benzoin ether type, phosphine oxide type, benzophenone type, thioxanthone type or quinone type. A phosphine oxide type or thioxanthone type photopolymerization initiator is preferred, and with a view to preventing coloration after the photopolymerization reaction, a phosphine oxide type is particularly preferred. In a case where the photopolymerization is carried out by high intensity light irradiation, it is preferred to use an acetophenone type photopolymerization initiator, whereby the curing speed may be increased. The content of the photopolymerization initiator (C2) in the resin composition is preferably from 0.01 mass % to 10 mass %, more preferably from 0.1 mass % to 5 mass %, to 100 mass % of the entirety of the curable compound (II) i.e. the sum of the oligomer (A′) and the monomer (B′).

### (Non-Curable Oligomer (D))

The non-curable oligomer (D) is an oligomer having a hydroxy group, which does not undergo a curing reaction with the curable compound (II) in the resin composition at the time of curing the resin composition. The number of hydroxy groups per one molecule of the non-curable oligomer (D) is preferably from 0.8 to 3, more preferably from 1.8 to 2.3. The number average molecular weight (Mn) per one hydroxy group, of the non-curable oligomer (D), is preferably from 400 to 8,000. When the number average molecular weight per one hydroxy group is at least 400, the polarity of the non-curable oligomer (D) will not be too high, and good compatibility with the curable compound (II) in the resin composition is readily obtainable. When the number average molecular weight per one hydroxy group is at most 8,000, it is possible to readily obtain the effect to stabilize the non-curable oligomer (D) after curing, by an interaction between the hydroxy group derived from the curable compound (II) and the hydroxy group of the non-curable oligomer (D). It is considered that a hydrogen bond contributes to such an interaction. Such non-curable oligomers (D) may be used alone or in combination of two or more of them.

The non-curable oligomer (D) having a hydroxy group, may, for example, be a polyol having a high molecular weight, and a polyoxyalkylene polyol, a polyester polyol or a polycarbonate polyol is preferred. The polyoxyalkylene polyol may, for example, be a polyoxyalkylene glycol such as polyoxyethylene glycol, polyoxypropylene glycol, polyoxypropylene glycol having a branched structure, or polyoxytetramethylene glycol.

The number average molecular weight (Mn) per one hydroxy group, of the polyoxyalkylene polyol is preferably from 400 to 8,000, more preferably from 600 to 5,000. The polyester polyol may, for example, be an aliphatic polyester diol having a residue of an aliphatic diol such as ethylene glycol, propylene glycol or 1,4-butanediol, and a residue of an aliphatic dicarboxylic acid such as glutaric acid, adipic acid or sebacic acid. The polycarbonate polyol may, for example, be an aliphatic polycarbonate diol having a diol residue of e.g. 1,6-hexanediol, or an aliphatic polycarbonate diol such as a ring-opened polymer of an aliphatic cyclic carbonate.

The number average molecular weight (Mn) per one hydroxy group, of the polyester polyol or a polycarbonate polyol is preferably from 400 to 8,000, more preferably from 800 to 6,000. In this specification, the number average molecular weight of the non-curable oligomer (D) is a value calculated by the following formula (1) from the hydroxy value A (mgKOH/g) measured in accordance with JIS K1557-1 (2007 edition) and the number B of hydroxy groups in one molecule of the non-curable oligomer (D).

Molecular weight of non-curable oligomer(D)=56.1×B×1000/A (1)

As the non-curable oligomer (D), it is preferred to use a polyoxyalkylene polyol, particularly preferably polyoxypropylene polyol, since the elastic modulus of the adhesive layer 20 after curing tends to be thereby lower. Further, part of oxypropylene groups in the polyoxypropylene polyol may be substituted by an oxyethylene group. For example, from the viewpoint of compatibility, it is preferred that the oligomer (A′) is a urethane oligomer synthesized by using a polyoxyalkylene polyol and a polyisocyanate as raw materials, and the non-curable oligomer (D) is a polyoxyalkylene polyol.

The non-curable oligomer (D) in the resin composition contributes to shortening of the time required for disappearance of air bubbles formed at the interface between the display panel and the adhesive layer 20 in the atmospheric pressure atmosphere after bonding the adhesive layer-equipped transparent plate 80 and the display panel, etc. under a reduce pressure or ordinary pressure atmosphere. If the content of the non-curable oligomer (D) in the resin composition is too small, it is likely that the desired effect is not obtainable, and if it is too large, curing of the adhesive layer 20 tends to be inadequate. If curing of the adhesive layer 20 is inadequate, it tends to be difficult to peel the first protective film 30 and the second protective film 31 from the adhesive layer 20 after curing. Therefore, the content of the non-curable oligomer (D) in the resin composition is preferably set within a range of from 10 mass % to 70 mass % in the entirety (100 mass %) of the resin composition, taking also the balance with other components into consideration, so as not to bring about such troubles.

The chain transfer agent (E) receives radicals from a polymer grown by radical polymerization thereby to prevent elongation of the polymer. Therefore, it is possible to adjust the molecular weight of the adhesive layer 20 after curing, by adjusting the content of the chain transfer agent (E).

The chain transfer agent (E) may, for example, be a compound having a thiol group (such as n-octylmercaptan, n-dodecylmercaptan, 1,4-bis(3-mercaptobutylyloxy)butane or pentaerythritol tetrakis(3-mercaptobutylate)).

In addition to the curable compound (II), the non-curable oligomer (D), the photopolymerization initiator (2) and the chain transfer agent (E), the resin composition may contain, as the case requires, various additives such as a polymerization inhibitor, a photocuring accelerator, a photostabilizer (such as a ultraviolet absorber or a radical scavenger), an antioxidant, a flame retardant, an adhesion-improving agent (such as a silane coupling agent), a pigment, a dye, etc., and it preferably contains a polymerization inhibitor, a photostabilizer, an antioxidant, etc. Particularly, by incorporating a polymerization inhibitor in an amount smaller than the polymerization initiator, it is possible to improve the stability of the resin composition and to adjust the molecular weight after curing. Further, by incorporating an antioxidant, it is possible to increase the stability of the resin composition after curing. The total amount of such additives is preferably at most 10 parts by mass, more preferably at most 5 parts by mass, per 100 parts by mass of the entirety of the curable compound (II), i.e. the sum of the oligomer (A′) and the monomer (B′).

The proportions of various components in the resin composition as described above, are adjusted so that the adhesive force of the high adhesion adhesive layer 21 and the adhesive force of the low adhesion adhesive layer 22 are different from each other. Specifically, in the resin composition, any one or a plurality of the proportions of the monomer (B3) having a hydroxy group in the curable compound (II), the non-curable oligomer (D) (non-curable component) and the chain transfer agent (E), are adjusted. Now, the respective proportions will be described.

The monomer (B3) is a polar component having a hydroxy group as a polar group, and therefore, as the proportion of the monomer (B3) in the curable compound (II) increases, or in other words, as the proportion of the monomer (B3) in the resin composition increases, the adhesion between the adhesive layer and the adherend will be improved. That is, by adjusting the proportion of the monomer (B3) in the curable compound (II) contained in the high adhesion resin composition 23 to be larger than the proportion of the monomer (B3) in the curable compound (II) contained in the low adhesion resin composition 24, the adhesive force of the high adhesion adhesive layer 21 can be made to be larger than the adhesive force of the low adhesion adhesive layer 22.

As the proportion of the non-curable oligomer (D) in the resin composition increases, the shear modulus of the adhesive layer at the time of curing the resin composition tends to be low, and the adhesive force between the adhesive layer and the adherend tends to be low. Therefore, by adjusting the proportion of the non-curable oligomer (D) contained in the high adhesion resin composition 23 to be smaller than the proportion of the non-curable oligomer (D) contained in the low adhesion resin composition 24, the adhesive force of the high adhesion adhesive layer 21 can be made to be larger than the adhesive force of the low adhesion adhesive layer 22.

On the other hand, if the proportions of the non-curable oligomer (D) contained in the high adhesion resin composition 23 and in the low adhesion resin composition 24 are different to a large extent, the adhesive force between the high adhesion adhesive layer 21 and the low adhesion adhesive layer 22 is likely to be low. Therefore, the difference in the proportion of the non-curable oligomer (D) between the high adhesion resin composition 23 and the low adhesion resin composition 24 is preferably made to be at most 20 points. In order to increase the adhesive force between the high adhesion adhesive layer 21 and the low adhesion adhesive layer 22, it is preferred to adjust the proportions of the non-curable oligomer (D) contained in the high adhesion resin composition 23 and in the low adhesion resin composition 24 to be substantially the same.

The chain transfer agent (E) prevents radical polymerization thereby to prevent growth of a polymer, and therefore, as its content in the resin composition increases, the molecular weight of molecules contained in the adhesive layer at the time of curing the resin composition tends to be small. If the molecular weight of molecules contained in the adhesive layer is small, the molecules in the adhesive layer tend to readily penetrate to fine irregularities formed on the surface of the adherend, whereby the adhesive force between the adhesive layer and the adherend can be improved. Therefore, by adjusting the proportion of the chain transfer agent (E) contained in the high adhesion resin composition 23 to be larger than the proportion of the chain transfer agent (E) contained in the low adhesion resin composition 24, the adhesive force of the high adhesion adhesive layer 21 can be made larger than the adhesive force of the low adhesion adhesive layer 22.

On the other hand, if the proportion of the chain transfer agent (E) is too large, the molecular weight of the cured product is likely to be too small, and the durability is likely to be impaired, so that the shape of the cured product is likely to change during high temperature storage. The proportion of the chain transfer agent (E) contained in the high adhesion resin composition 23 is preferably at most 1.5 wt %, more preferably at most 1.0 wt %. The low adhesion resin composition 24 may not contain the chain transfer agent (E), but if no chain transfer agent (E) is contained, the shear modulus of the low adhesion adhesive layer 22 tends to be high, and voids formed during bonding to a display device tend to hardly disappear after bonding. The low adhesion resin composition preferably contains at least 0.1 wt % of the chain transfer agent (E).

In this embodiment, with respect to any one, or two or more, among the above-described monomer (B3), non-curable oligomer (D) and chain transfer agent (E), the proportions in the high adhesion resin composition 23 and in the low adhesion resin composition are adjusted as described above. That is, in order to adjust the adhesive force of the high adhesion adhesive layer 21 to be larger than the adhesive force of the low adhesion adhesive layer 22, the proportion of the monomer (B3) is made larger, the proportion of the non-curable oligomer (D) is made smaller, or the proportion of the chain transfer agent (E) is made larger in the high adhesion resin composition 23, than the proportion of the corresponding component in the low adhesion resin composition 24.

The adjustment of the proportion of each component is not particularly limited, so long as the adhesive force of the high adhesion adhesive layer 21 becomes larger than the adhesive force of the low adhesion adhesive layer 22. In this embodiment, for example, with respect to the chain transfer agent (E), as mentioned above, the proportion contained in the high adhesion resin composition 23 is made larger than the proportion contained in the low adhesive resin composition 24, and with respect to the non-curable oligomer (D), contrary to the above-mentioned, the proportion contained in the high adhesion resin composition 23 may be made larger than the proportion contained in the low adhesive resin composition 24.

In this case, if attention is drawn only to the proportion of the non-curable oligomer (D), the adhesive force of the high adhesion adhesive layer 21 is adjusted to become smaller than the adhesive force of the low adhesion adhesive layer 22, but by making adjustment so that the degree for improving the adhesive force of the high adhesion adhesive layer 21 by the difference in the proportion of the chain transfer agent (E) exceeds the degree for lowering the adhesive force of the high adhesion adhesive layer 21 by the difference in the proportion of the non-curable oligomer (D), it is consequently possible to make the adhesive force of the high adhesion adhesive layer 21 larger than the adhesive force of the low adhesion adhesive layer 22.

### <Method for Producing Double Sided Adhesive Film>

In this embodiment, firstly adhesive film original materials 11 and 12 each having an adhesive layer constituted by one layer, are produced, and then, they are bonded to each other to produce a double sided adhesive film 10.

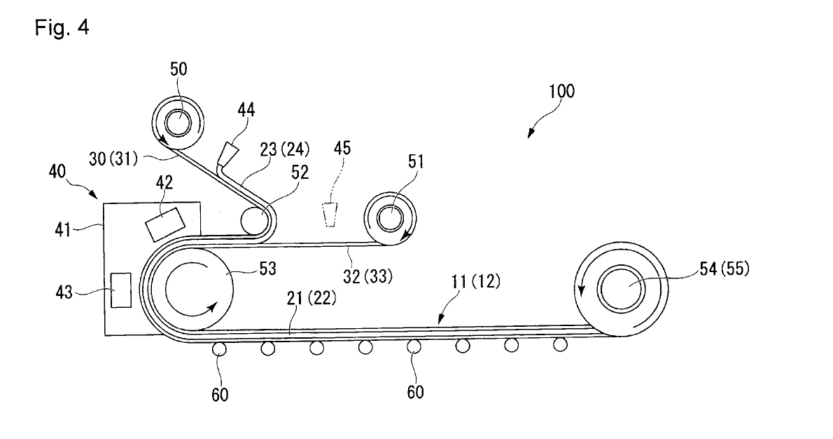

FIG. 4 is a schematic diagram showing a production apparatus 100 as an example of the production apparatus to produce the adhesive film original materials 11 and 12 each having an adhesive layer constituted by one layer. Now, the method for producing such adhesive film original materials 11 and 12 by means of the production apparatus 100 will be described.

As shown in FIG. 4, the production apparatus 100 comprises a feed roll 50, a feed roll 51, an applying part 44, a bonding roll 52, a curing part 40, a backup roll 53 and conveying rolls 60.

The feed roll 50 is a roll to sequentially wind off a first protective film 30 wound up in a roll state. The feed roll 51 is a roll to sequentially wind off a third protective film 32 wound up in a roll state. The third protective film 32 has the same construction as the first protective film 30 and temporarily protects the surface of an adhesive layer. That is, the third protective film 32 is not one that finally remains in the double sided adhesive film 10 of this embodiment, but is one to be used only in the production process.

The applying part 44 is an applicator to apply a liquid high adhesion resin composition 23 in a continuous strip form on the surface of the first protective film 30 wound off by the feed roll 50.

The first protective film 30 having the high adhesion resin composition 23 applied, is bonded to the third protective film 32 via the high adhesion resin composition 23 by a bonding roll 52. The first protective film 30 and the third protective film 32 bonded via the high adhesion resin composition 23, is transported to a curing part 40.

The curing part (light irradiation device in this embodiment) comprises a chamber 41, and a light source 42 and a light source 43 disposed in the chamber 41. In the example shown in FIG. 4, there are two light sources, but the number of light sources may be one, or three or more.

Inside of the chamber 41 is made to be an inert gas atmosphere. For example, inside of the chamber is filled with nitrogen so that the oxygen concentration is controlled to be at most 100 ppm. Since inside of the chamber 41 is kept under an inert gas atmosphere, at the time of irradiating the resin composition with ultraviolet rays (light irradiation) for a curing reaction, it is possible to prevent a side reaction by oxygen to deactivate radicals formed in the resin composition by irradiation with ultraviolet rays.

The light sources 42 and 43 are light sources capable of applying ultraviolet rays. As the light sources 42 and 43, a commonly known high pressure mercury lump or metal halide lump may, for example, be used.

The first protective film 30 and the third protective film 32 bonded via the high adhesion resin composition 23, is turned around in the chamber 41 by a backup roll 53 and irradiated with ultraviolet rays by the light sources 42 and 43. By irradiation with ultraviolet rays, the high adhesion resin composition 23 is cured to form a high adhesion adhesive layer 21. Thus, an adhesive film original material 11 having the high adhesion adhesive layer 21 sandwiched by the first protective film 30 and the third protective film 32, is produced.

The adhesive film original material 11 is transported by a plurality of conveying rolls 60 and wound up by an original material roll 54.

An adhesive film original material 12 having an adhesive layer constituted by a single-layered low adhesion adhesive layer 22 is produced in the same manner as described above, by means of the production apparatus 100 and wound up by an original material roll 55. In this case, from the feed roll 50, a second protective film 31 is wound off, and from the feed roll 51, a fourth protective film 33 is wound off. The structure and handling of the fourth protective film 33 are the same as of the third protective film 32. Further, from the applying part 44, a low adhesion resin composition 24 is ejected.

The adhesive film original materials 11 and 12 produced as described above, are bonded to produce a double sided adhesive film 10 of this embodiment.

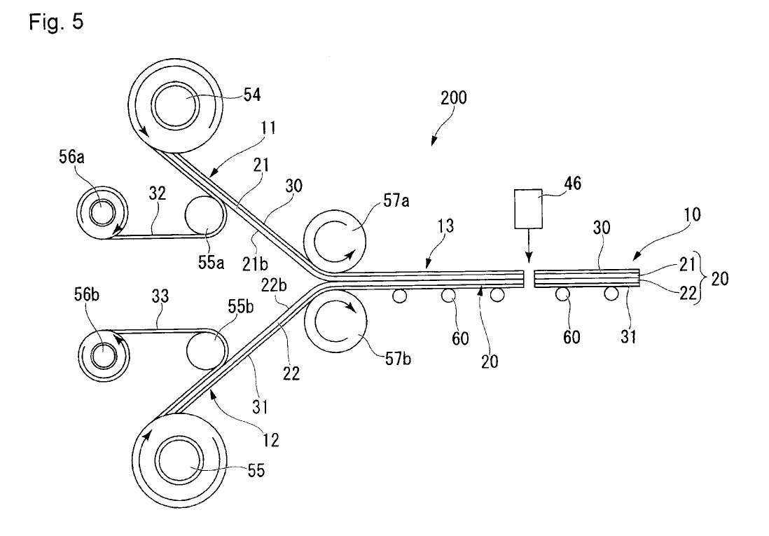

FIG. 5 is a schematic diagram showing a bonding apparatus 200 as an example of the bonding apparatus for producing a double sided adhesive film 100 of this embodiment by bonding the adhesive film original materials 11 and 12. Now, the method for producing a double sided adhesive film 100 by means of the bonding apparatus 200 will be described.

As shown in FIG. 5, the bonding apparatus 200 comprises an original material roll 54, an original material roll 55, a protective film wind-up roll 56a, a protective film wind-up roll 56b, a peel-off roll 55a, a peel-off roll 55b, a bonding roll 57a, a bonding roll 57b, conveying rolls 60 and a cutting part 46.

The original material roll 54 sequentially winds off the adhesive film original material 11 wound up in a roll state by the production apparatus 100, and in the same manner, the original material roll 55 sequentially winds off the adhesive film original material 12 wound up in a roll state by the production apparatus 100.

The third protective film 32 of the wound-off adhesive original material 11 is wound up on the protective film wind-up roll 56a via the peel-off roll 55a, whereby the lamination surface 21a of the high adhesion adhesive layer 21 is exposed.

The fourth protective film 33 of the wound-off adhesive original material 12 is wound up on the protective film wind-up roll 56b via the peel-off roll 55b, whereby the lamination surface 22b of the low adhesion adhesive layer 22 is exposed.

The adhesive film original materials 11 and 12 having the lamination surfaces 21b and 22b respectively exposed, are sandwiched by the bonding rolls 57a and 57b so that the lamination surfaces 21b and 22b abut each other and bonded, whereby a double sided adhesive film original material 13 having an adhesive layer 20 is produced.

The double sided adhesive film original material 13 is transported by a plurality of conveying rolls 60. The transported double sided adhesive film original material 13 is cut by the cutting part 46 to individual pieces. The cutting part 46 is, for example, a laser cutter in this embodiment.

Thus, a double side adhesive film 10 is produced.

### <Adhesive Layer-Equipped Transparent Plate>

The adhesive layer-equipped transparent plate 80 is, for example, an adhesive layer-equipped protective plate to be bonded to e.g. a display panel of a liquid crystal display device.

As shown in FIG. 3, the adhesive layer-equipped transparent plate 80 comprises a protective plate 81, a light-shielding printed portion 82, an adhesive layer 20 and a second protective film 31.

The adhesive layer 20 is one bonded to the upper surface 81a of the protective plate 81 via the high adhesion adhesive layer 21, after peeling off the first protective film 30 from the double sided adhesive film 10 shown in FIG. 2. That is, the adhesive layer-equipped transparent plate 80 in this embodiment is produced, for example, by bonding the double sided adhesive film 10 of this embodiment.

### (Protective Plate)

The protective plate 81 is a transparent flat plate. The plan view shape of the protective plate 81 is not particularly limited and may be suitably set depending upon the shape of a display panel to which the protective plate is to be bonded, or a display device provided with a display panel. The plan view shape of the protective plate 81 is, for example, rectangular.

The protective plate 81 is provided on the image display surface side of the display panel to protect the display panel. The material for the protective plate may, for example, be a glass plate or a transparent resin plate. As the material for the protective plate 81, a glass plate is most preferred, not only from the viewpoint of the high transparency to emitted light or reflected light from the display panel but also from the viewpoint of the light resistance, low birefringence, high flatness, surface scratching resistance and high mechanical strength. The glass plate is preferred also from such a viewpoint that light to cure the after-described photocurable resin composition can be sufficiently passed therethrough.

As the protective plate 81, a plate curved in one direction may also be used. In such a case, for example, when the adhesive layer-equipped transparent plate 80 is to be bonded to a thin display panel, the display panel may be bent in the same direction as the curved direction of the protective plate 81 to bond the adhesive layer-equipped transparent plate 80 to the display panel.

As the material for the glass plate, a glass material such as soda lime glass may, for example, be mentioned, and a high transmission glass (white plate glass) having a lower iron content and less bluish tone, is more preferred. In order to increase the safety, reinforced glass may be used as the surface material. Especially when a thin glass plate is to be used, it is preferred to employ a glass plate subjected to chemical tempering.

As the material for a transparent resin plate, a resin material having high transparency (such as polycarbonate or polymethyl methacrylate) may be mentioned.

Surface treatment may be applied to the protective plate 81 in order to improve the interfacial adhesive force with the high adhesion adhesive layer 21 in the adhesive layer 20. As such surface treatment, a method of treating the surface of the protective plate 81 with a silane coupling agent, or a method of forming a thin film of silicon oxide by oxidative flame by a flame burner, may, for example, be mentioned.

To the protective plate 81, in order to increase the contrast of a display image, an anti-reflection layer may be provided at the lower surface 81b on the opposite side (−Z side) to the side (+Z side) at which the adhesive layer 20 is formed. The anti-reflection layer may be provided by a method of directly forming an inorganic thin film on the surface of the protective plate 81, or a method of bonding a transparent resin film having an anti-reflection layer to the protective plate 81.

Further, depending upon the purpose, the protective plate 81 may be partly or entirely colored; part or whole of the surface of the protective plate 81 may be made to be ground-glass to scatter light; or fine irregularities may be formed on part or whole of the surface of the protective plate 81 to refract or reflect transmitted light. Or, a colored film, a light-scattering film, a light-refracting film, a light-reflecting film, etc. may be bonded to part or whole of the surface of the protective plate 81.

In the case of a glass plate, the thickness of the protective plate 81 is usually from 0.5 mm to 25 mm from the viewpoint of the mechanical strength and transparency. In applications to e.g. TV receivers, PC displays, etc. to be used indoor, the thickness is preferably from 0.5 mm to 6 mm with a view to weight reduction of the display device, and in applications to public displays to be installed outdoor, the thickness is preferably from 3 mm to 20 mm. In the case of using chemically tempered glass, the thickness of glass is preferably from 0.4 mm to 1.5 mm from the viewpoint of the strength. In the case of a transparent resin plate, the thickness is preferably from 2 mm to 10 mm.

### [Light-Shielding Printed Portion]

The light-shielding printed portion 82 is a decorative printed portion formed in a frame shape. The light-shielding printed portion 82 makes invisible other than the image display region of the display panel from the protective plate 81 side, thereby shield wiring members, etc. connected to the display panel. The light-shielding printed portion 82 may be formed on the upper surface 81a of the protective plate 81 at the side (+Z side) where the adhesive layer 20 is to be formed, or on the lower surface 81b of the protective plate 81 at the opposite side. In the example shown in FIG. 3, the light-shielding printed portion 82 is formed on the upper surface 81a. With a view to reducing the disparity between the light-shielding printed portion 82 and the image display region, the light-shielding printed portion 82 is preferably formed on the upper surface 81a of the protective plate 81 at the side (+Z side) where the adhesive layer 20 is to be formed. In a case where the protective plate 81 is a glass plate, it is preferred to use ceramic printing containing a black pigment at the light-shielding printed portion 82.

In a case where the light-shielding printed portion is to be formed on the lower surface 81b at the opposite side (−Z side) to the side where the adhesive layer is formed, it is possible to form it by bonding a transparent film preliminarily provided with the light-shielding printed portion to a protective plate. A film prepared by forming a light-shielding printed portion along the periphery of a transparent film on the side to be bonded to a protective plate and forming an anti-reflection layer on its opposite side i.e. on the outermost surface of the display device, may be bonded to a protective plate. A light-shielding printed portion may not be formed in the case of a construction such that wiring members, etc. of the display panel are invisible from the side viewing the display panel, or shielded by another member such as a casing of the display device, or in a case where an adherend other than a display panel and the adhesive layer-equipped transparent plate are to be bonded.

### <Method for Producing Adhesive Layer-Equipped Transparent Plate>

The adhesive layer-equipped transparent plate 80 may be produced by bonding a double sided adhesive film 10 to a protective plate 81 as described above, or may be produced by another production method as described below.

As another production method for the adhesive layer-equipped transparent plate 80, for example, a method may be employed wherein adhesive film original materials 11 and 12 each having an adhesive layer constituted by one layer, produced in a stage prior to the production of a double sided adhesive film 10, are cut into individual pieces, which are then sequentially bonded to protective plates 81.

That is, firstly the adhesive film original material 11 having the high adhesion adhesive layer 21 is cut into individual pieces, and the first protective film 30 is peeled off, whereby the bonding surface 21a of the high adhesion adhesive layer 21 is exposed.

Then, the bonding surface 21a of the high adhesion adhesive layer 21 thus exposed, is brought in contact with the protective plate 81 to bond the high adhesion adhesive layer 21 to the upper surface 81a of the protective plate 80.

Then, the adhesive film original material 12 having the low adhesion adhesive layer 22 is cut into individual pieces. And, the fourth protective film 23 of the adhesive film original material 12 cut into individual pieces, and the third protective film 32 bonded to the high adhesion adhesive layer 21 bonded on the protective plate 81, are peeled off, whereby the lamination surface 22b of the low adhesion adhesive layer 22 and the lamination surface 21b of the high adhesion adhesive layer 21 are exposed.

Then, the lamination surface 22b of the low adhesion adhesive layer 22 and the lamination surface 21b of the high adhesion adhesive layer 21 are brought in contact with each other to laminate and bond the low adhesion adhesive layer 22 on the high adhesion adhesive layer 21.

Thus, the adhesive layer-equipped transparent plate 80 is produced.

Further, as another production method for the adhesive layer-equipped transparent plate 80, for example, a method of forming an adhesive layer 20 directly on the upper surface of a protective plate 81 may be employed. In this case, after forming the high adhesion adhesive layer 21 on the upper surface 81a of the protective plate 80, the low adhesion adhesive layer 22 is formed as laminated on the high adhesion adhesive layer 21. The method for forming each adhesive layer is not particularly limited, and for example, it may be formed by applying the resin composition by means of a die coating method, or may be formed by a method wherein after applying the resin composition by means of e.g. a dispenser, films are bonded to each other in a reduced pressure atmosphere, followed by releasing under the atmospheric pressure.

Further, in this embodiment, after forming the high adhesion adhesive layer 21 on the protective plate 81, ultraviolet rays may be applied to the high adhesion adhesive layer 21 from the protective plate 81 side (−Z side), whereby it is possible to further improve the adhesive force between the high adhesion adhesive layer 21 and the protective plate 81.

Further, in this embodiment, ultraviolet rays may be applied after laminating the low adhesion adhesive layer 22 on the high adhesion adhesive layer 21, whereby it is possible to further improve the adhesive force between the high adhesion adhesive layer 21 and the low adhesion adhesive layer 22.

Among conventional double sided adhesive films, there was one constituted by a plurality of different resin layers. However, there was no disclosure to provide different adhesive forces in such a plurality of resin layers for their respective adherends, for example, in a case where easy reworking is required as in the case of bonding between the display device and its protective plate. While as shown in this specification, prescribed adhesive forces may be controlled by a plurality of resin compositions, it cannot be said that different resin layers necessarily exhibit different adhesive forces, and there was no report on evaluation of the respective adhesive forces at both surfaces of a resin layer from the viewpoint of reworking easiness.

According to this embodiment, it is possible to obtain a double sided adhesive film and an adhesive layer-equipped transparent plate, capable of improving reworkability. Now, this will be described in detail.

At the time of bonding the adhesive layer-equipped transparent plate to an adherend such as a display device, the protective film is peeled off, and the exposed surface of the adhesive layer is brought in contact with the adherend to bond the adhesive layer-equipped transparent plate to the adherend. At that time, for example, in a case where the position to bond the adhesive layer-equipped transparent plate is dislocated, or a foreign matter is included between the adhesive layer and the adherend, it is required to once peel off the adhesive layer-equipped transparent plate and then bond it again.

However, if the adhesive layer-equipped transparent plate once bonded was peeled, the adhesive layer was likely to be divided and part thereof remained on the bonded surface of the adherend. In such a case, at the time when the adhesive layer-equipped transparent plate was bonded again, there was such a problem that the bonded surface would not be flat due to the adhesive layer remained, and good display properties were not obtained. Therefore, it was necessary to clean the bonded surface of the adherend to remove the remained adhesive layer, such being time and labor consuming.

Further, since part of the adhesive layer was divided and lost also in the peeled adhesive layer-equipped transparent plate, if such plate was bonded to the adherend again, the interface between the adhesive layer and the adherend would not become flat, and good display properties would not be obtained. Therefore, there was a problem such that it was necessary to prepare a fresh adhesive layer-equipped transparent plate, such being costly.

In consideration of such problems, according to the double sided adhesive film of this embodiment, the composition of the resin composition is different as between the bonding surface 21a and the bonding surface 22a in the adhesive layer 20. Accordingly, the bonding surface having a relatively larger adhesion to the protective plate 81, i.e. in this embodiment, the bonding surface 21a as a surface of the high adhesion adhesive layer 21, is utilized as the side for bonding to the protective plate 81, and the other surface, i.e. in this embodiment, the bonding surface 22a as a surface of the low adhesion adhesive layer 22, is utilized as the side for bonding to the adherend. If such a manner is adopted, even in a case where the protective plate 81 is to be peeled after once bonded, it becomes easy to peel the adhesive layer 20 together with the protective plate 81. Thus, it is possible to prevent the adhesive layer 20 from being divided and to prevent the adhesive layer 20 from being divided and remaining on the bonding surface of the adherend. As a result, according to this embodiment, it becomes possible to bond the protective plate 81 again and to improve the reworkability. Therefore, according to this embodiment, it is possible to reduce the labor and costs in a case where it is required to peel the protective plate again.

Further, according to this embodiment, the proportions of components in the resin composition as a forming material, are different as between the high adhesion adhesive layer 21 to be bonded to the protective plate 81 and the low adhesion adhesive layer 22 to be bonded to e.g. a display panel of a display device. That is, in this embodiment, in the high adhesion resin composition 23, the proportion of the monomer (B3) contained as a polar component is larger, the proportion of the non-curable oligomer (D) contained as a non-curable component is smaller, or the proportion of the chain transfer agent (E) contained, is larger, than in the low adhesion resin composition 24. It is thereby possible to make the adhesive force of the high adhesion adhesive layer 21 to the protective plate 81 larger than the adhesive force of the low adhesion adhesive layer 22 to the display device.

Further, according to this embodiment, the types of components in the resin compositions for forming the high adhesion adhesive layer 21 and the low adhesion adhesive layer 22 are the same. Therefore, the affinity between the high adhesion adhesive layer 21 and the low adhesion adhesive layer 22 is high, and the high adhesion adhesive layer 21 and the low adhesion adhesive layer 22 are firmly bonded to each other. Thus, according to this embodiment, it is possible to prevent the high adhesion adhesive layer 21 and the low adhesion adhesive layer 22 from being separated at the interface, at the time of reworking.

Particularly, among components in the resin compositions for forming the high adhesion adhesive layer 21 and the low adhesion adhesive layer 22, it is further preferred to make the ratios of components other than the content of the chain extender to be the same, whereby it is possible to increase the adhesive force between the high adhesion adhesive layer 21 and the low adhesion adhesive layer 22.

Further, according to the adhesive layer-equipped transparent plate of this embodiment, by adjusting the proportion of the non-curable oligomer (D) contained in the high adhesion resin composition 23 to be larger than the proportion of the non-curable oligomer (D) contained in the low adhesion resin composition 24, it is possible to obtain an adhesive layer-equipped transparent plate whereby workability is high at the time of bonding and the adhesion improves as time passes after being bonded. This will be described below in detail.

For an adhesive layer-equipped transparent plate, such reworkability is required that the protective plate (transparent plate) can easily be peeled at the time of bonding to e.g. a display device, while after the protective plate is bonded at a predetermined position, the protective plate is required to be hardly peeled. In other words, it is required that before a predetermined time has passed from the bonding, the adhesive force between the adhesive layer and the display device is small, and after a predetermined time has passed from the bonding, the adhesive force between the adhesive layer and the display device is large.

Here, as a finding made by the present inventors, it may be mentioned that the non-curable oligomer (D) moves depending upon the concentration gradient. That is, the non-curable oligomer (D) has a nature to migrate from a location where the concentration is high towards a location where the concentration is low. It is thereby possible to obtain an adhesive layer-equipped transparent plate having the above-mentioned nature.

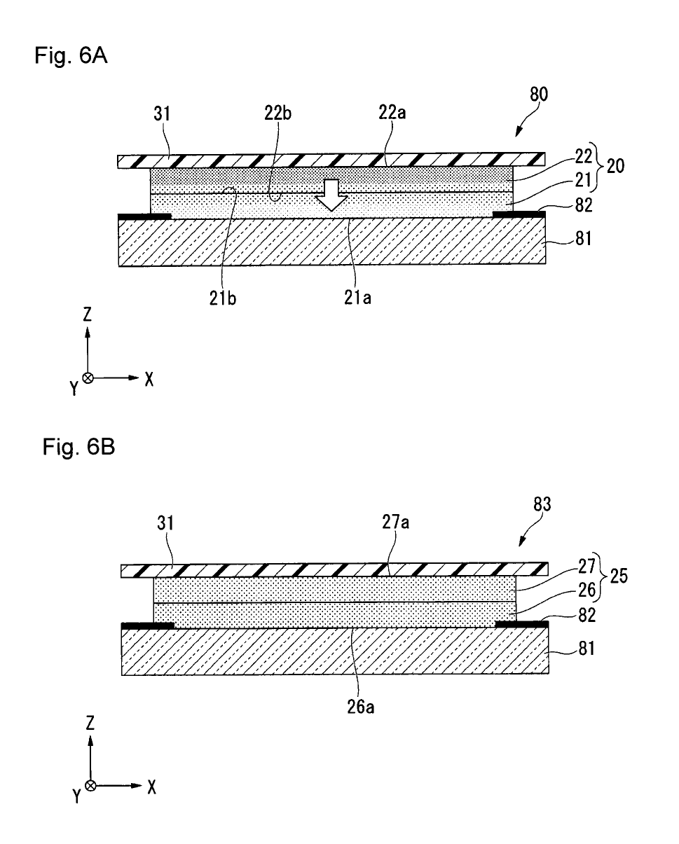

FIGS. 6 (A) and (B) are drawings for illustrating the change in the nature of the adhesive layer 20 by migration of the non-curable oligomer (D). In FIGS. 6 (A) and (B), the proportion of the non-curable oligomer (D) contained in the resin composition is schematically shown as represented by the hatching density.

In a case where the proportion of the non-curable oligomer (D) contained in the low adhesion resin composition 24 is larger than the proportion of the non-curable oligomer (D) contained in the high adhesion resin composition 23, the non-curable oligomer (D) moves from the low adhesion adhesive layer 22 towards the high adhesion adhesive layer 21. Accordingly, the proportion of the non-curable oligomer (D) changes as the time passes so that as shown in FIG. 6A, the proportion of the non-curable oligomer (D) becomes smaller from the bonding surface 22a of the low adhesion adhesive layer 22 towards the lamination surface 22b (lamination surface 21b) and the bonding surface 21a of the high adhesion adhesive layer 21.

And, as a prescribed time passes, as shown in FIG. 6B, an adhesive layer 25 which comprises a low adhesion adhesive layer 27 having the proportion of the non-curable oligomer (D) decreased, and a high adhesion adhesive layer 26 having the proportion of the non-curable oligomer (D) increased, will be formed. Thus, the proportion of the non-curable oligomer (D) in the low adhesion adhesive layer 27 becomes small, and the adhesive force of the low adhesion adhesive layer 27 is improved. In other words, the adhesive layer-equipped transparent plate 80 having the low adhesion adhesive layer 22 which can be easily peeled from the adherend, becomes, as a prescribed time passes, an adhesive layer-equipped transparent plate 83 having a low adhesion adhesive layer 27 having the adhesive force to the adherend improved. Thus, according to this embodiment, it is possible to obtain an adhesive layer-equipped transparent plate which has high reworkability at the time of bonding and whereby upon expiration of a prescribed time after bonding, the adhesive force between the adhesive layer and the display device is improved.

Here, in fact, the migration of the non-curable oligomer (D) is considered to cease when the difference in the proportion of the non-curable oligomer (D) contained, has decreased to a certain level. That is, although in FIG. 6B, the proportion of the non-curable oligomer (D), i.e. the hatching degree, is shown to be equal as between the low adhesion adhesive layer 27 and the high adhesion adhesive layer 26 after expiration of a prescribed time, it is considered that in fact, the migration of the non-curable oligomer (D) ceases at a stage when the difference between the proportion of the non-curable oligomer (D) in the high adhesion adhesive layer 21 and the proportion of the non-curable oligomer (D) in the low adhesion adhesive layer 22, has decreased to a certain level.

Further, in FIG. 6B, the concentration is shown to be uniform in each of the low adhesion adhesive layer 27 and the high adhesion adhesive layer 26, but in fact, it is considered to have such a concentration distribution that the proportion of the non-curable oligomer (D) decreases continuously or non-continuously from the bonding surface 27a of the low adhesion adhesive layer 27 towards the bonding surface 26a of the high adhesion adhesive layer 26.

The speed for migration of the non-curable oligomer (D) changes depending upon the concentration gradient or the temperature. That is, the speed for migration of the non-curable oligomer (D) becomes fast as the concentration gradient becomes large or the temperature becomes high.

Further, the migration of the non-curable oligomer (D) can be prevented by keeping the temperature of the adhesive layer 20 to be low. Thus, prior to bonding to a display device, the adhesive layer-equipped transparent plate is preferably stored at a low temperature.

Further, in this embodiment, the following construction may be adopted.

In the above-described embodiment, a case wherein the monomer (B3) is used as a polar component has been described, but the present invention is not limited thereto. The adhesive force of the adhesive layer tends to be large as the proportion of the polar component becomes large, and in this embodiment, the adhesive force of the high adhesion adhesive layer 21 and the adhesive force of the low adhesion adhesive layer 22 may be adjusted by adjusting the proportion of other polar components. Further, in this embodiment, a polar component having a polar group other than a hydroxy group may be used.

Further, in the above-described embodiment, each of the high adhesion resin composition 23 and the low adhesion resin composition 24 is one containing all of the monomer (B3), the non-curable oligomer (D) and the chain transfer agent (E), but the present invention is not limited thereto. In this embodiment, in adjustment of proportions of the respective components, there may be a component which is not contained in either one of the resin compositions. That is, as a specific example, in the case of reducing the proportion of the non-curable oligomer (D) contained in the high adhesion resin composition 23 to be smaller than the proportion of the non-curable oligomer (D) contained in the low adhesion resin composition 24, the high adhesion resin composition 23 may be made to be one containing no non-curable oligomer (D). That is, the proportion of the non-curable oligomer (D) in the high adhesion resin composition 23 may be made to be 0%. The same applies to the content of the chain transfer agent.

Further, in this embodiment, so long as the composition of the resin composition at the bonding surface 21a of the high adhesion adhesive layer 21 is different from the composition of the resin composition at the bonding surface 22a of the low adhesion adhesive layer 22, the distribution of components of the resin composition inside of the high adhesion adhesive layer 21 and the distribution of components of the resin composition inside of the low adhesion adhesive layer 22, are not particularly limited.

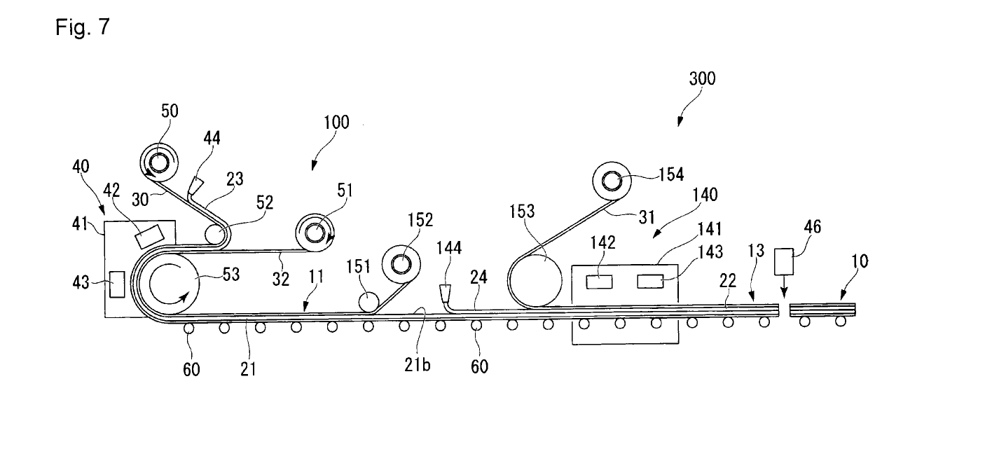

Further, in the above-described embodiment, as the method for producing a double sided adhesive film, a method is used wherein the adhesive film original material 11 having the high adhesion adhesive layer 21 and the adhesive film original material 12 having the low adhesion adhesive layer 22 are produced by means of the production apparatus 100, and then, they are bonded by means of the bonding apparatus 200, but the present invention is not limited thereto. In this embodiment, the double sided adhesive film 10 may be produced by means of a production apparatus 300 as shown in FIG. 7.

FIG. 7 is a schematic drawing showing a production apparatus 300 as another example of the apparatus for producing a double sided adhesive film.

As shown in FIG. 7, the production apparatus 300 comprises a production apparatus 100, a peel-off roll 151, a protective film wind-up roll 152, an applying part 144, a bonding roll 153, a feed roll 154, a curing part 140, and a cutting part 46.

From an adhesive film original material 11 having a high adhesion adhesive layer 21 produced by the production apparatus 100, a third protective film 32 is peeled by the protective film wind-up roll 102 via the peel-off roll 151, whereby a lamination surface 21b of the high adhesion adhesive layer 21 is exposed.

On the lamination surface 21b of the high adhesion adhesive layer 21, a liquid low adhesion resin composition 24 is continuously applied in a strip shape. And, on the surface of the low adhesion resin composition 24, a second protective film 31 wound off from the feed roll 154 is bonded via the bonding roll 153. The double sided adhesive film original material having the second protective film 31 bonded, is transported into a chamber 141 of the curing part 140 by the conveying rolls 60.

In the chamber 141, ultraviolet rays are applied to the low adhesion resin composition 24 by light sources 142 and 143. The chamber 141 and the light sources 142 and 143 are the same as the above-mentioned chamber 41 and light sources 42 and 43, respectively. Thus, the low adhesion resin composition 24 is cured to form a low adhesion adhesive layer 22, whereby a double sided adhesion film original material 13 is produced.

The double sided adhesion film original material 13 is cut into individual pieces by the cutting part 46, whereby a double sided adhesive film 10 is produced.

By this production apparatus, the double sided adhesive film 10 can be produced in one line, such being convenient.

Further, this embodiment may have such a construction that to the production apparatus 100 shown in FIG. 4, an applying part 45 shown by a two-dot chain line is added. In such a construction, by the applying part 44 and the applying part 45, the high adhesion resin composition 23 and the low adhesion resin composition 24 are applied to have two layers laminated before being cured, and then the two layers are cured together in the curing part 40 to form the adhesive layer 20.

In the above description, the cutting part 46 is a laser cutter, but it is not limited thereto. In this embodiment, the cutting part 46 is not particularly limited so long as it is capable of cutting the double sided adhesive film original material 13 into individual pieces, and for example, it may have such a construction that the double sided adhesive film original material 13 is cut by a rotary blade. However, in such a case that the double sided adhesive film is soft and the shear modulus is smaller than 100 kPa, it is preferred to use a laser cutter with a view to preventing re-attachment after cutting.

Further, the adhesive layer-equipped transparent plate 80 in this embodiment is described to have such a construction that the adhesive layer 20 is formed only on the upper surface 81a of the protective plate 81, but the construction is not limited thereto. In this embodiment, the construction may be such that the adhesive layer 20 is formed on each of the upper surface 81a and the lower surface 81b of the protective plate 81. That is, this embodiment may have such a construction that the adhesive layer is formed on each of both sides of the protective plate 81. In such a case, the compositions of the adhesive layers may be different from each other or may be the same, as between the adhesive layer to be formed on the upper surface 81a and the adhesive layer to be formed on the lower surface 81b.

### Second Embodiment

The second embodiment is different from the first embodiment in that 3 layers of adhesive layers are provided.

In the following description, with respect to the same constructions as in the above embodiment, the same symbols may be applied so that their descriptions may be omitted.

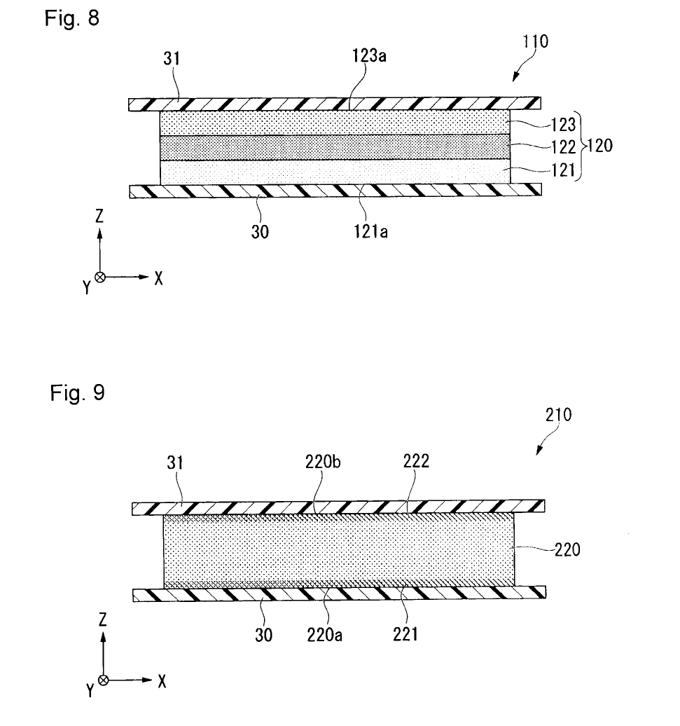

FIG. 8 is a cross-sectional view showing the double sided adhesive film 110 of this embodiment.

As shown in FIG. 8, the double sided adhesive film 110 of this embodiment has an adhesive layer 120. On the bonding surface (first surface) 121a at one side (−Z side) of the adhesive layer 120, the first protective film 30 is bonded. On the bonding surface (second surface) 123a at the other side (+Z side) of the adhesive layer 120, the second protective film 31 is bonded.

The adhesive layer 120 comprises a high adhesion adhesive layer (first adhesive layer) 121, an intermediate adhesive layer (third adhesive layer) 122 and a low adhesion adhesive layer (second adhesive layer) 123.

The high adhesion adhesive layer 121 has a bonding surface 121a. The low adhesion adhesive layer 123 has a bonding surface 123a.

The high adhesion adhesive layer 121 is the same as the high adhesion adhesive layer 21 in the first embodiment. The low adhesion adhesive layer 123 is the same as the low adhesion adhesive layer 22 in the first embodiment.

The intermediate adhesive layer 122 is a layer which connects the high adhesion adhesive layer 121 and the low adhesion adhesive layer 123.

The high adhesion adhesive layer 121, the low adhesion adhesive layer 123 and the intermediate adhesive layer 122 are, respectively, formed by curing the same resin compositions as the resin compositions described in the first embodiment.

In the high adhesion adhesive layer 121, the low adhesion adhesive layer 123 and the intermediate adhesive layer 122, the proportions of components contained in the resin compositions to form them, are different from one another. That is, the proportions of components of the resin composition at the bonding surface 121a and the proportions of components of the resin composition at the bonding surface 123a are different from each other. Specifically, the proportions of the monomer (B3), the non-curable oligomer (D) and the chain transfer agent (E) as described in the first embodiment, are different in any one of them or a plurality of them, whereby the adhesive forces in the respective adhesive layers are adjusted.

In the high adhesion adhesive layer 121 and the low adhesion adhesive layer 123, the proportions of the respective components are adjusted so that the adhesive force of the high adhesion adhesive layer 121 becomes larger than the adhesive force of the low adhesion adhesive layer 123, in the same manner as in the high adhesion adhesive layer 21 and the low adhesion adhesive layer 23 as described in the first embodiment.

The proportions of components in the resin composition to form the intermediate adhesive layer 122 are adjusted so that the high adhesion adhesive layer 121 and the low adhesion adhesive layer 123 can thereby be bonded well.

In this embodiment, the intermediate adhesive layer 122 is provided, whereby the high adhesion adhesive layer 121 and the low adhesion adhesive layer 123 can be bonded well via the intermediate adhesive layer 122 by adjusting the composition of the intermediate adhesive layer 122, for example, even in a case where the affinity between the low adhesion adhesive layer 123 and the high adhesion adhesive layer 121 would be low as the compositions of the high adhesion adhesive layer 121 and the low adhesion adhesive layer 123 are so different.

Here, in the example shown in FIG. 8, the respective adhesive layers are shown to have substantially the same thickness (length in Z axis direction), but the present invention is not limited thereto. For example, the thicknesses of the high adhesion adhesive layer 121 and the low adhesion adhesive layer 123 may be made sufficiently small as compared to the thickness of the intermediate adhesive layer 122. By such a construction, the entire physical properties of the adhesive layer 120 are determined mainly by the physical properties of the intermediate adhesive layer 122, whereby it is easy to adjust the physical properties of the adhesive layer 120 while maintaining reworkability.

### Third Embodiment

The third embodiment is different from the first embodiment in that instead of making the adhesive layer to have a double layered laminate structure, different surface treatments are applied to the two surfaces of one adhesive layer.

In the following description, with respect to the same constructions as in the above embodiments, the same symbols may be applied so that their descriptions may be omitted.

FIG. 9 is a cross-sectional view showing the double sided adhesive film 210 of this embodiment.

As shown in FIG. 9, the double sided adhesive film 210 of this embodiment has an adhesive layer 220.

On the bonding surface (first surface) 220a at one side (−Z side) of the adhesive layer 220 and on the bonding surface (second surface) 220b at the other side (+Z side), surface treatments are, respectively, applied, to form a high adhesion surface-treated portion (first bonding layer) 221 and a low adhesion surface-treated portion (second bonding layer) 222.

The high adhesion surface-treated portion (first bonding layer) 221 and the low adhesion surface-treated portion (second bonding layer) 222 are formed so that their adhesive forces are different from each other. Specifically, in the resin compositions to form the high adhesion surface-treated portion 221 and the low adhesion surface-treated portion 222, respectively, the proportions of the monomer (B3), the non-curable oligomer (D) and the chain transfer agent (E), as described in the first embodiment, are different in any one of them or a plurality of them.

As the method for surface treatments, it is possible to select a method of changing the proportions of components in the composition, for example, by adding any one of the monomer (B3), the non-curable oligomer (D) and the chain transfer agent (E) to the bonding surface 220a or 220b of the adhesive layer 220 before curing or after being semi-cured. Or, by adding the non-curable oligomer (D) to the bonding surface 220b of the adhesive layer 220 after curing, it is possible to apply low adhesive surface treatment.

According to this embodiment, one adhesive layer is formed, followed by surface treatment to produce the double sided adhesive film, such being convenient.

### <Laminate>

Now, as an example of the laminate, a display device will be described.

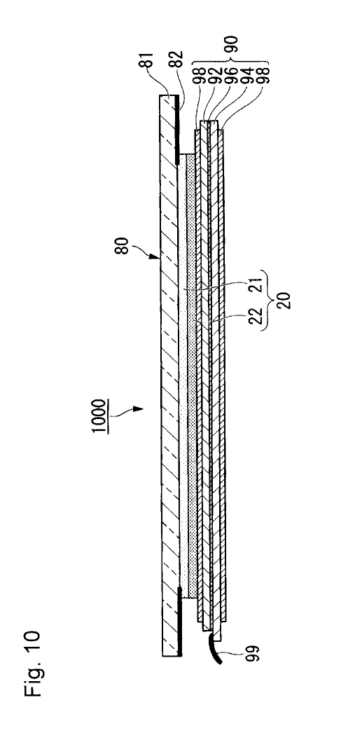

FIG. 10 is a cross-sectional view showing an embodiment of the display device.

The display device (laminate) 1000 of this embodiment comprises a display panel (adherend) 90, an adhesive layer-equipped transparent plate 80 bonded to the display panel 90 so that the low adhesion adhesive layer 22 in the adhesive layer 20 is in contact with the display panel 90, and a flexible printed circuit board 99 connected to the display panel and having a driving IC mounted to drive the display panel 90.

The display panel 90 is a liquid crystal display panel having such a construction that a transparent substrate 92 having a color filter, and a transparent substrate 94 having TFT (thin film transistor) are bonded via a liquid crystal layer 96, and such an assembly is sandwiched by a pair of polarizing plates 98.

The display device 1000 is produced by bonding the adhesive layer-equipped transparent plate 80 as described in the above embodiments, to the display panel 90. That is, the display device 1000 is produced by peeling off the second protective film 31 of the adhesive layer-equipped transparent plate 80, and bonding the bonding surface 22a of the low adhesion adhesive layer 22 to the display panel 90.

For example, in such a display device 1000, by adjusting the adhesive force of the high adhesion adhesive layer 21 and the adhesive force of the low adhesion adhesive layer 22 by the proportion of the non-curable oligomer (D), it is possible to improve reworkability at the time of bonding the display panel 90 and the adhesive layer-equipped transparent plate 80 and to improve the adhesive force between the display panel 90 and the protective plate 81 as time passes.

Here, in the embodiment of the above display device, an example of using, as an adhesive layer-equipped transparent plate, the adhesive layer-equipped transparent plate 80 having the adhesive layer 20 in the double sided adhesive film 10, is shown, but the display device is not limited thereto. The display device in this embodiment may have, as an adhesive layer, the adhesive layer 120 or 220 in the double sided adhesive film 110 or 210.

### EXAMPLE

An example of the first embodiment was produced, and the adhesive force of the high adhesion adhesive layer and the adhesive force of the low adhesion adhesive layer were, respectively, measured. The high adhesion adhesive layer and the low adhesion adhesive layer were made to be different only in the proportion of the chain transfer agent (E). The resin compositions for the adhesive layer were as follows.

### [Resin Compositions]

Bifunctional polypropylene glycol having molecular terminals modified with ethylene oxide (number average molecular weight calculated by hydroxy value: 4,000) and isophorone diisocyanate were mixed in a molar ratio of 4:5 and reacted at 70° C. in the presence of a tin catalyst to obtain a prepolymer. To the obtained prepolymer, 2-hydroxyethyl acrylate was added in a molar ratio of 1:2 and reacted at 70° C. to obtain urethane acrylate oligomer (A-1) (hereinafter referred to as “oligomer (A-1)”). Oligomer (A-1) had two curable functional groups, a number average molecular weight of about 24,000 and a viscosity of about 830 Pas at 25° C. The viscosity of a resin composition was measured by means of an E-type viscometer at 25° C.

40 parts by mass of oligomer (A-1), 40 parts by mass of 2-hydroxybutyl methacrylate (Light ester HOB, manufactured by Kyoeisha Chemical Co., Ltd.) and 20 parts by mass of n-dodecyl methacrylate, were uniformly mixed to obtain 100 parts by mass of a resin mixture. To 100 parts by mass of the resin mixture, 0.3 part by mass of bis(2,4,6-trimethylbenzoyl)-phenylphosphine oxide (photopolymerization initiator, IRGACURE 819, manufactured by Ciba Specialty Chemicals), 0.04 part by mass of 2,5-di-tert-butyl hydroquinone (polymerization inhibitor, manufactured by Tokyo Chemical Industry Co., Ltd.) and a predetermined proportion of n-dodecylmercaptan (chain transfer agent (E), Thiokalcol 20, manufactured by Kao Corporation) were uniformly dissolved to obtain a base composition. With respect to the proportion of the chain transfer agent, different proportions were adopted for a low adhesion resin composition and a high adhesion resin composition. In the high adhesion resin composition, the proportion of the chain transfer agent (E) was made to be 1.0 part by mass, and in the low adhesion resin composition, the proportion of the chain transfer agent (E) was made to be 0.1 part by mass. Thus, two types of base compositions were obtained.

Then, 60 parts by mass of the base composition and 40 parts by mass of the non-curable oligomer (D) were uniformly mixed and set in a reduced pressure apparatus in an open state, as put in a container. Inside of the reduced pressure apparatus was depressurized to about 20 Pa and kept for 10 minutes for defoaming treatment to obtain a resin composition. As the non-curable oligomer (D), the same bifunctional polypropylene glycol having molecular terminals modified with ethylene oxide (number average molecular weight calculated by hydroxy value: 4,000) as the one used for the synthesis of oligomer (A-1) was used.

Using the resin compositions obtained as described above, a double sided adhesive film was produced, and the adhesive forces of the respective adhesive layers were measured. The polarizing plate used, was one taken out from a commercially available liquid crystal monitor (U2212HM manufactured by Dell Inc.).

As a result, the adhesive force to the polarizing plate, of the low adhesion adhesive layer, was 0.3N/25 mm, and the adhesive force to glass was 0.1N/25 mm.

Whereas the adhesive force to glass, of the high adhesion adhesive layer was 4.0N/25 mm. Thus, it was confirmed that it is possible to adjust the adhesive force of an adhesive layer by changing the proportion of the chain transfer agent (E), and specifically, it was confirmed that it is possible to improve the adhesive force by increasing the proportion of the chain transfer agent (E) in the resin composition.

The low adhesion adhesive layer and the high adhesion adhesive layer were laminated, and the shear modulus at 25° C. was measured by means of a dynamic viscoelasticity measuring apparatus and found to be 25 kPa.

In this Example, as an object for evaluating the adhesive force, a polarizing plate was used as an example of a constituting member (adherend) of a display device, and glass was used as an example of a protective plate, but the object is not limited thereto so long as it is a member to be used for a surface of a display device. For example, a glass member may be used for the surface of a display device for 3D display. In order to carry out reworking stably, the adhesive force between the high adhesion adhesive layer and glass is preferably at least twice the adhesive force between the low adhesion adhesive layer and each adherent. When the former is at least three times the latter, it becomes possible to carry out reworking more stably.

By the foregoing, the usefulness of the present invention has been confirmed.

### REFERENCE SYMBOLS

10, 110, 210: double sided adhesive film, 20, 120, 220: adhesive layer, 21, 121: high adhesion adhesive layer (first adhesive layer), 21a, 121a, 220a: bonding surface (first surface), 22, 123: low adhesion adhesive layer (second adhesive layer), 22a, 123a, 220b: bonding surface (second surface), 23: high adhesion resin composition (resin composition), 24: low adhesion resin composition (resin composition), 80: adhesive layer-equipped transparent plate, 81: protective plate (transparent plate), 90: display panel (adherend), 122: intermediate adhesive layer (third adhesive layer), 221: high adhesion surface-treated portion (first adhesive layer), 222: low adhesion surface-treated portion (second adhesive layer), 1000: display device (laminate)

The entire disclosures of Japanese Patent Application No. 2014-139912 filed on Jul. 7, 2014 including specifications, claims, drawings and summaries are incorporated herein by reference in their entireties.

What is claimed is:

1. A double sided adhesive film which has an adhesive layer made of a resin composition as a forming material and which is capable of bonding an adherend and a protective plate, wherein the adhesive layer has a first surface and a second surface on the opposite side of the first surface, the composition of the resin composition at the first surface and the composition of the resin composition at the second surface are different from each other, and the adhesive force between the first surface and the protective plate is larger than the adhesive force between the second surface and the adherend.

2. The double sided adhesive film according to claim 1, wherein the shear modulus at 25° C. of the entire adhesive layer is from 1 kPa to 50 kPa.

3. The double sided adhesive film according to claim 1, wherein the resin composition contains a chain transfer agent, and the proportion of the chain transfer agent at the first surface is larger than the proportion of the chain transfer agent at the second surface.

4. The double sided adhesive film according to claim 1, wherein the resin composition contains a polar component, and the proportion of the polar component at the first surface is larger than the proportion of the polar component at the second surface.

5. The double sided adhesive film according to claim 1, wherein the resin composition contains a non-curable component, and the proportion of the non-curable component at the first surface is smaller than the proportion of the non-curable component at the second surface.

6. The double sided adhesive film according to claim 1, wherein the adhesive layer comprises a first adhesive layer having the first surface and a second adhesive layer having the second surface, and the composition of the resin composition in the first adhesive layer and the composition of the resin composition in the second adhesive layer are different from each other.

7. The double sided adhesive film according to claim 6, wherein the adhesive layer further contains a third adhesive layer provided between the first adhesive layer and the second adhesive layer, and the composition of the resin composition in the third adhesive layer is different from the composition of the resin composition in the first adhesive layer and is different from the composition of the resin composition in the second adhesive layer.

8. An adhesive layer-equipped transparent plate comprising a transparent plate and the double sided adhesive film as defined in claim 1, bonded to the transparent plate.

9. An adhesive layer-equipped transparent plate to be bonded to an adherend, which comprises a transparent plate and an adhesive layer formed on at least one surface of the transparent plate, wherein the adhesive layer is formed of a resin composition and has a first surface on the transparent plate side and a second surface on the opposite side of the first surface, the composition of the resin composition at the first surface and the composition of the resin composition at the second surface are different from each other, and the adhesive force between the first surface and the transparent plate is larger than the adhesive force between the second surface and the adherend.

10. The adhesive layer-equipped transparent plate according to claim 9, wherein the shear modulus at 25° C. of the entire adhesive layer is from 1 kPa to 50 kPa.

11. The adhesive layer-equipped transparent plate according to claim 9, wherein the adhesive layer is formed of laminated at least two types of the resin composition different in the composition from one another, and is provided on each of both surfaces of the transparent plate.

12. The adhesive layer-equipped transparent plate according to claim 9, wherein the resin composition contains a chain transfer agent, and the proportion of the chain transfer agent at the first surface is larger than the proportion of the chain transfer agent at the second surface.

13. The adhesive layer-equipped transparent plate according to claim 9, wherein the resin composition contains a polar component, and the proportion of the polar component at the first surface is larger than the proportion of the polar component at the second surface.

14. The adhesive layer-equipped transparent plate according to claim 9, wherein the resin composition contains a non-curable component, and the proportion of the non-curable component at the first surface is smaller than the proportion of the non-curable component at the second surface.

15. A laminate comprising a transparent plate, an adhesive layer formed on at least one surface of the transparent plate, and an adherend bonded to the transparent plate via the adhesive layer, wherein a resin composition forming the adhesive layer contains a non-curable component, the adhesive layer has a first surface on the transparent plate side and a second surface on the opposite side of the first surface, and the proportion of the non-curable component at the first surface is smaller than the proportion of the non-curable component at the second surface.

16. The laminate according to claim 15, wherein the adherend is a display device.
